(19) United States
(12) Patent Application Publication
(10) Pub. No.: US 2011/0307566 A1
(43) Pub. Date: Dec. 15, 2011

(54) System for automatically appending digital correspondence compositions with status updates outputted by an iteration of a qualified user defined function

(76) Inventor: Victor Yeung, Toronto (CA)

(21) Appl. No.: 13/185,247

(22) Filed: Jul. 18, 2011

(51) Int. Cl. G06F 15/16

(52) U.S. Cl. 709/206

(57) ABSTRACT

The present invention provides monitoring a correspondence for at least one of a content and a property; accessing a library of UDFs comprised of a UDF rules and a status update logics; evaluating at least one of the UDF rules against at least one of the content and the property; determining at least one qualified UDF based on UDF rules satisfied by the evaluating; executing the status update logic associated with the qualified UDFs to return a plurality of results based on at least one of the content and the property; generating a composite status update with the plurality of results; and appending the composite status update to the correspondence.

### FIELD

The invention relates to the field of email clients and networks and more particularly to techniques of automatically appending updated facts, statuses, statistics, and graphics to digital correspondences.

### BACKGROUND

Electronic signatures such as email signatures provide a convenient way to automatically append text to the end of a digital textual message. In work environments where email is a form of communication, people may work towards specific states, conditions, tasks and goals. These tasks and goals may be collaboratively set with projected timelines and completion dates. A shortcoming of the current environment is that status updates pertaining to these tasks and goals must be manually inputted into correspondences if at all. The status updates may not be relevant to all recipients and so the user needs to manually assess whether to include particular status updates when composing email to send to a variety of recipients. At times the user may lack the knowledge and time to retrieve information to create a status update.

### SUMMARY

The present invention aims to solve one or more of these and other problems. The invention provides a way to automatically and discriminately append status updates to an active user's digital correspondence composition or email where the status update is the output of a qualified user defined function (UDF) from a list of UDFs. The UDF may be created, monitored, and calculated by the present invention and defined by a user or a group of users.

### GUI

In a preferred embodiment, the invention includes an interface or graphical user interface (GUI) where a user can create, edit and select multiple UDFs.

In another preferred aspect, the GUI may allow users to edit how status updates will graphically appear when appended to correspondence compositions including properties such as font, font size, font color, font effects, and other graphical properties.

In another preferred aspect, the GUI may allow users to approve or not approve status updates outputted to their correspondence compositions.

### UDF

In a preferred embodiment, the invention includes a user defined function (UDF).

In a preferred aspect, a UDF may comprise a method for measuring and evaluating a subject and returning a status update pertaining to the measured subject wherein the subject may be a state or condition in the past, present or future. For example the UDF may count the age of a project and return a status update stating the following “Working on Internet project with Jason for 23 days”. Further examples of subjects a UDF could measure include:
a) a price quote of a traded stock or security
b) a listing of projects assigned
c) a listing of settings or properties on a computer terminal
d) a listing of people with a particular status
e) a countdown towards a deadline, anniversary, or special event
f) a count of days since inception of a project
g) a count of days without a reported injury
h) a count of currency earned
i) a count of clients won
j) a count of emails in an inbox
k) a count of email responses in a particular email thread or discussion
1) a calculation of percentage of work complete
m) a measurement of a computer task performed

In another preferred aspect, a UDF may be a scalar function or a table function.

In another preferred aspect, a UDF may comprise of UDF rules, UDF parameters, UDF parameter values, and status update logic.

### UDF Parameter

In another preferred aspect, a UDF parameter may be a subject concerning: a text, a property, or a property-of-text. An example of each of these includes a keyword text, a time property, and an association of a keyword such as the social rank of a keyword representing a person.
a) Examples of text subjects include: an email recipient, an email subject field, text in an email body,
b) Examples of property subjects include: a time, a date, an event, a season
c) Examples of property-of-text subjects include: an event associated with the text representing a composer, a social rank of the text representing a recipient

### UDF Parameter Values

In another preferred aspect, a UDF parameter value may be populated by content and properties taken from a correspondence.

In another preferred aspect, a UDF parameter value may take values approved by UDF rules.

### UDF Rules

In another preferred aspect, UDF rules state when and when not to invoke a UDF

In another preferred aspect, UDFs may be governed by additional rules

In another preferred aspect, the additional rules may rate UDFs and correspondence parties where a sufficient rating is required to create and receive status updates of a particular rating.

In another preferred aspect, UDF rules may assign UDFs a private status, such that status updates are appended correspondences only if the recipient list is exclusive to particular list of email accounts. As an example a user may send an email to multiple recipients but all the recipients may have different profile ratings. In such a case, all the recipients would receive a status update of the lowest common denomination.

### UDF Voluntary/Mandatory/Collaborative/Imported

In another preferred aspect, a UDF may be voluntary and self-imposed by a user.

In another preferred aspect, a UDF may be mandatory or assigned by a second-user thereby forcing a first user to append particular status updates to their correspondence whenever they send emails to particular recipients or any recipients in general.

In another preferred aspect, a UDF can be collaboratively developed and shared between multiple users.

In another preferred aspect, a UDF can be updated and imported from external project management software applications such as Microsoft Project.

In another preferred aspect, a UDF can compiles status updates by taking data from external applications or databases such as Microsoft Excel, Microsoft Access, or SAP.

In another preferred aspect, a UDF may self-terminate and be discontinued upon a UDF rule being satisfied.

### Status Update

In a preferred embodiment, the invention includes a status update.

In a preferred aspect, the status update may comprise of dynamic and static variables.

In a preferred aspect, the static variable may be inputted by a user.

In a preferred aspect, the dynamic variable may comprise of variables defined by a user.

In a preferred aspect, the status update may be calculated by logic configured with functions that take some or no values.

In a preferred aspect, the status update may be calculated by logic configured to lookup data from external sources or applications.

In another preferred aspect, the status update may comprise a link or filepath to a generated site that may include a report of facts, figures, or graphics.

In another preferred aspect, the generated site may be created upon the execution of a UDF.

In another preferred aspect, the generated site may be located on a local network or further along in a cloud computing platform.

In another preferred aspect, the status update may be appended above or below the user's email signature.

In another preferred aspect, the status update may include graphics comprised of: pictures, photos, videos, animations, diagrams, graphs, charts, sparklines, or maps.

In practice, status updates could be automatically and discriminately appended to correspondences based on listed email recipients or email content. This can speed communication, and would save users from having to manually calculate and input status updates into their correspondences. Users would not need to reevaluate which recipients to send particular status updates by establishing predefined settings. Status updates can serve as reminders to keep users accountable to tasks they have defined for themselves or tasks assigned to them by others. Status updates may serve to communicate info that is not readily available and info that the user lacks sufficient knowledge to retrieve. For example, an automatic status update directed to a tech support operator could include info not known to the user.

### Status Update Agent

In a preferred embodiment, the invention includes a status update agent.

In a preferred aspect, the status update agent monitors content of new correspondences for text and properties that may be used to invoke a UDF.

In a preferred aspect, the status update agent reviews all UDF rules to determine the most applicable UDFs and status updates to append to a correspondence, an email, or email signature.

In another preferred aspect, the status update agent may determine and select a plurality of applicable UDFs and status updates to append to a correspondence.

In another preferred aspect, the status update agent executes instructions provided by a UDF or higher governing authority to retrieve data and calculate status updates.

In another preferred aspect, the status update agent may retrieve data via internal and external measuring tools, internal databases, external databases, or manually inputted facts or figures.

In another preferred aspect, the status update agent may communicate with email applications, other applications to calculate status updates.

In another preferred aspect, the status update agent grants particular users administrator access to organization-wide UDFs, UDF rules, UDF ratings, and account profile ratings thereby capable of granting and revoking related privileges

### Location

In a preferred embodiment, the status update agent may reside locally on an individual computer terminal, externally on an email exchange server or further along in a cloud computing platform.

In a preferred embodiment, the status update agent may be part of an existing email application such as Microsoft Outlook or may exist as a plug-in application that communicates with an existing email application.

### BRIEF DESCRIPTION OF THE DRAWINGS

The present embodiments may be better understood, and numerous objects, features, and advantages made apparent to those skilled in the art by referencing the accompanying drawings.

FIG. 1 is a block diagram illustrating a client server system configured to determine and append status updates to email messages based on UDFs, according to some embodiments of the invention.

FIG. 2 is a block diagram of an exemplary structure of the system for enabling appending status updates to electronic messages based on UDFs.

FIG. 3 is a general flow chart of a method for enabling correspondences to be monitored and appended with status updates by comparing content and properties with rules.

FIG. 4 is a conceptual flow diagram illustrating concepts associated with appending a status message to an email composition, according to some embodiments of the invention.

FIG. 5 is a block diagram illustrating a computer system configured to monitor and append a correspondence with a status update according to some embodiments of the invention.

### DETAILED DESCRIPTION

In the following description, the use of “a”, “an”, or “the” can refer to the plural. All examples given are for clarification only and are not intended to limit the scope of the invention. In some instances, well-known instruction instances, protocols, structures, and techniques have not been show in detail in order not to obscure the description.

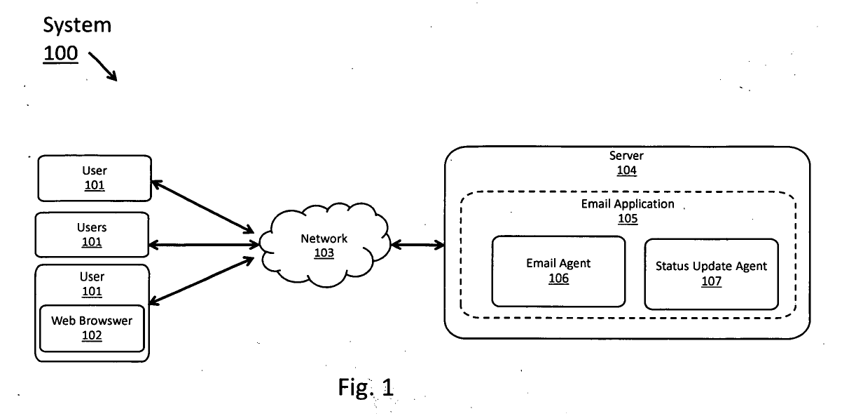

FIG. 1 illustrates a schematic diagram showing the environment of a system 100 for appending status updates to email compositions. The system 100 may include multiple client or user terminals 101 which may be interfaced through with a web browser 102. In some embodiments the user 101 may be in the form of a PC, PDA, cellphone etc. The users 101 may all be interconnected to each other via a network 103. The users 101 may have their email application 105 hosted on a server 104. The email application 105 may have an email agent 106 that communicates with the system 100 and coordinates with other applications namely a status update agent 107. The status update agent 107 monitors content of new email compositions to invoke operations that would return a status update that could be appended to the email composition.

In some embodiments the email application 105, email agent 106, and status update agent 107, may reside in part or wholly on a user terminal 101, a web browser 102, a network 103, a server 104, or in a cloud computing platform.

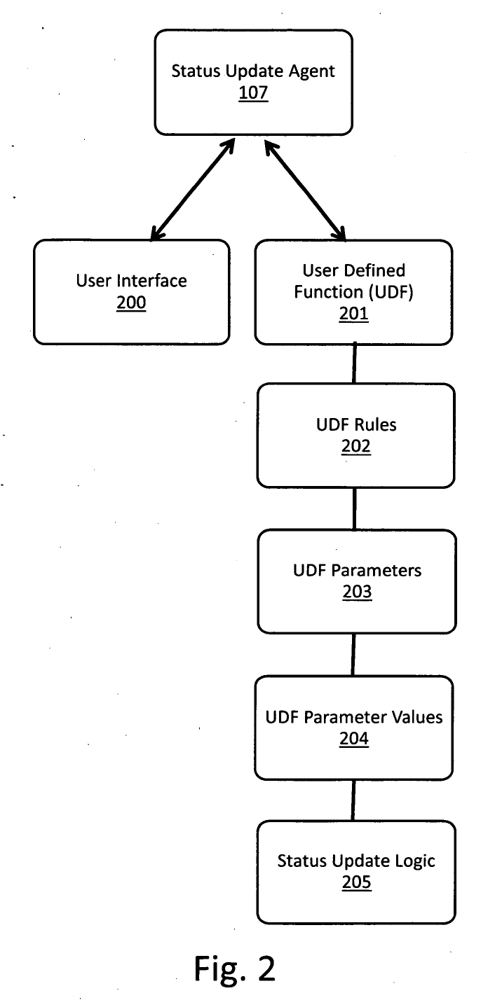

### FIG. 2

FIG. 2 is a block diagram of an exemplary structure of part of the system 100 and comprises of a status update agent 107. The status update agent 107 provides a user interface 200 where a user 101 may create, edit, and select a plurality UDFs 201.

The UDF 201 can be defined by a user 101 or multiple users 101 and includes components that operate to return a status update 406. The UDF 201 pertains to a subject defined by the user 101 that may concern a state or condition in the past, present or future. The UDF 201 may be defined with UDF rules 202 comprising of UDF parameters 203 such as email addresses, keywords and dates and populated with actual UDF parameter values 204 such as “scott@ibm.com”, “Pfizer account”, “Jan. 1, 1999”. The UDF rule 202 may further comprise of IF, AND, OR, NOT, ELSE, ELSE IF logic.

The status update agent 107 collects content and properties from an originating email application 105 or correspondence composition 400 inputted by users 101 to determine appropriate UDFs 201 to implement by reading the UDF rules 202. When the status update agent 107 identifies appropriate UDFs 201, it executes the status update logic 205 associated with the UDF 201 to return an output that is passed back to the status update agent 107. The status update agent 107 then passes the output to the correspondence application which may be an email application 105 communicating via an email agent 106 and proceeds with displaying the output as a status update 406 in the originating active composition 400.

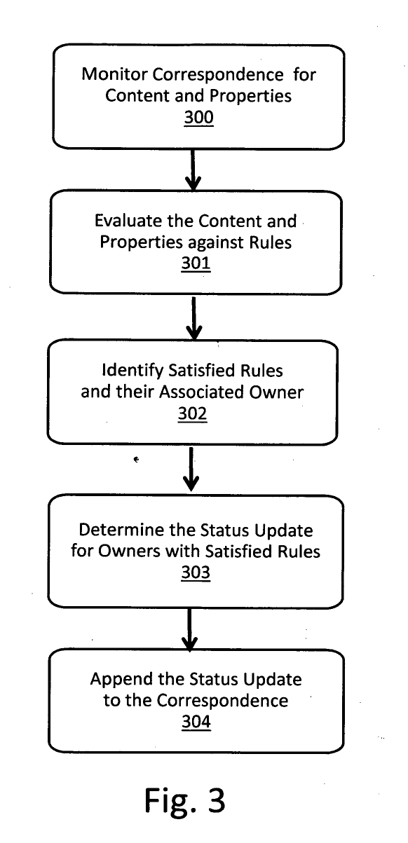

### FIG. 3

FIG. 3 is a flow diagram illustrating operations for monitoring text and properties of a correspondence to output an appropriate status update to append to the correspondence. The following discussion will describe FIG. 3 with reference to a client server system.

In step 300, the status update agent 107 monitors content and properties 403 in a correspondence 400. The correspondence 400 may be actively being engaged by a user 101 actively editing content. The correspondence 400 may be instantiated by an email application 105 or other textual communication application.

In step 301, the status update agent 107 accesses a UDF library 407 to evaluate the content and properties 403 against UDF rules 202 comprised of UDF parameters 203 and UDF parameter values 204.

In step 302, the status update agent 107 identifies UDF rules 202 that are satisfied by the content and properties 403. The status update agent 107 also identifies the owner of the satisfied UDF rules 202, where the owner may be a UDF 201.

In step 303, the status update agent 107 determines the output result of the identified UDF 201 by executing status update logic 205 owned by the UDF 201.

In step 304, the status update agent 107 passes the result to the correspondence 400 to append as a status update 406.

FIG. 3 does not illustrate other steps involved in connecting and passing information between an email application 105 or other textual communication application and a status update agent 107. An exemplary scenario in which the present invention is applied is detailed below to better describe the system and methods according to the embodiments of the present invention described above.
a) First a user 101 opens a new email composition 400.
b) As the user inputs content into the email 400, the status update agent 107 identifies any content such an email address 401 or keywords in the subject 402 or keywords in the email body 404 or properties of the email such as the date 403 that coincide with existing UDF parameters 203 and UDF parameter values 204 to shortlist UDFs 201 that are candidates to be outputted.
c) The status update agent 107 considers only UDFs 201 with UDF rules 202 that are satisfied by the content values and property values of the email 400.
d) Once UDFs 201 with satisfied UDF rules 202 are identified, the UDF's 201 associated status update logic 204 is executed to determine the current result of the UDF 201 where the output may differ in different iterations.
e) The current results are passed to the status update agent 107 which then passes the results to an email application 105 which can append the results as a status update 406 in the email composition 400.
f) As the user 101 adds or decreases content to the email composition 400, or as the property values of the correspondence 403 change, the status update agent 107 may repeat the above method and change the outputted status update 406 accordingly.
g) Upon the user 101 updating the email composition 400, the status update agent 201 determines if the outputted status update 406 needs to be updated and notifies the user 101 that the status update 406 needs to be changed.

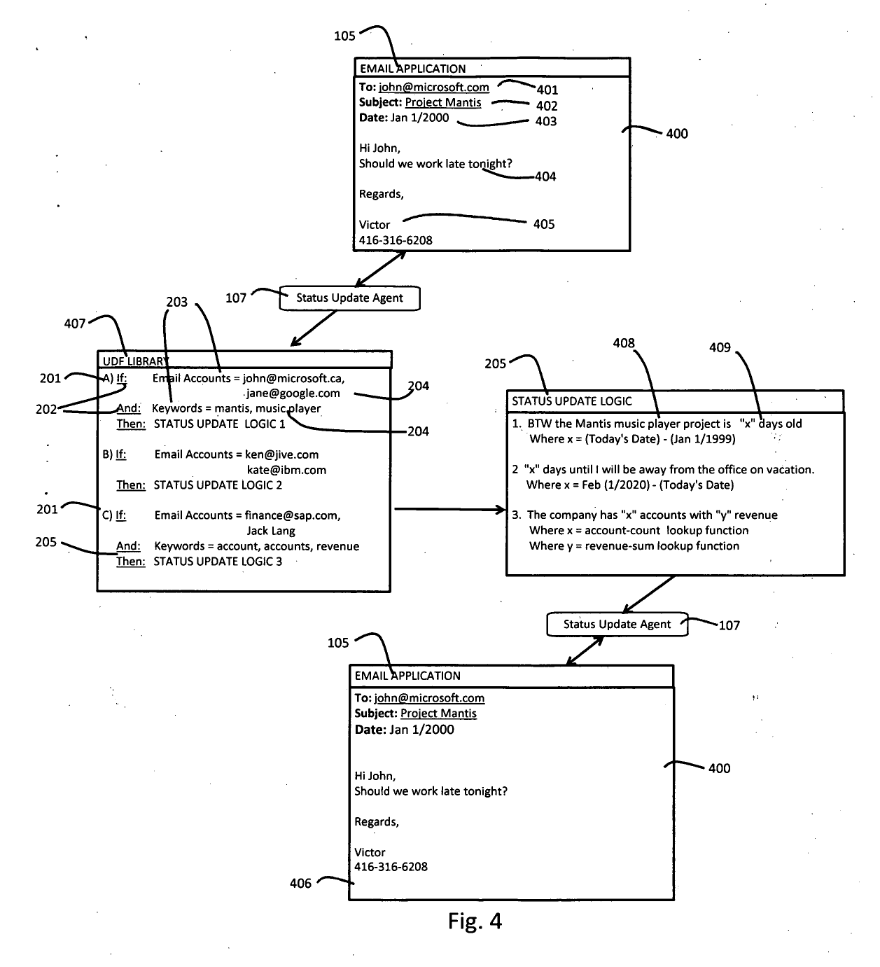

### FIG. 4

FIG. 4 is a conceptual flow diagram illustrating concepts associated with monitoring and appending correspondences 400 with status updates 406 according to some embodiments of the invention. FIG. 4 shows a screenshot of an email composition 400 and how a user 101 may type an email 400 indicating that a status update 406 should be appended to the email 400.

As the user 101 enters content which may be an email address 401, a subject header value 402, or part of the email body 404, the status update agent 107 monitors the activity. As properties of the correspondence 400 update, including the date 403 or other temporal properties, the status update agent 107 monitors and takes note. The status update agent 107 takes the content values and properties values from the correspondence 400 to compare against a UDF library 407.

The status update agent 107 accesses the UDF library 407 that has UDFs 201 that comprise of UDF rules 202 with UDF parameters 203 such as email accounts and keywords, and UDF parameter values 204 such as “finance@sap.com”, “Jack Lang”, “accounts”, “music player”, and “Matnis”.

The status update agent 107 compares values taken from the correspondence 400 to check if there are any UDFs 201 with UDF rules 202 all satisfied. If there are UDFs 201 with UDF rules 202 all satisfied, then status update agent 107 proceeds with executing the associated status update logic 205 owned by the UDF.

In the example in FIG. 4, the status update logic 205 executed is “STATUS UPDATE LOGIC 1”. This particular status update logic 205 is comprised of static variables 408 in the form of the text “BTW the Mantis music player project is” and dynamic variables 409 in the form of place holder “x” that will be calculated using the date property value 403 taken from the correspondence 400.

The result of the status update logic 205 is passed to the status update agent 107 which then instructs the email application 105 to append the result into the correspondence 400 as a status update 406. In this example the status update 406 is the text value “BTW the Mantis music player project is 365 days old” where the text “365” is in a larger sized font, which could have been configured in the status update logic 205 but not illustrated in this example.

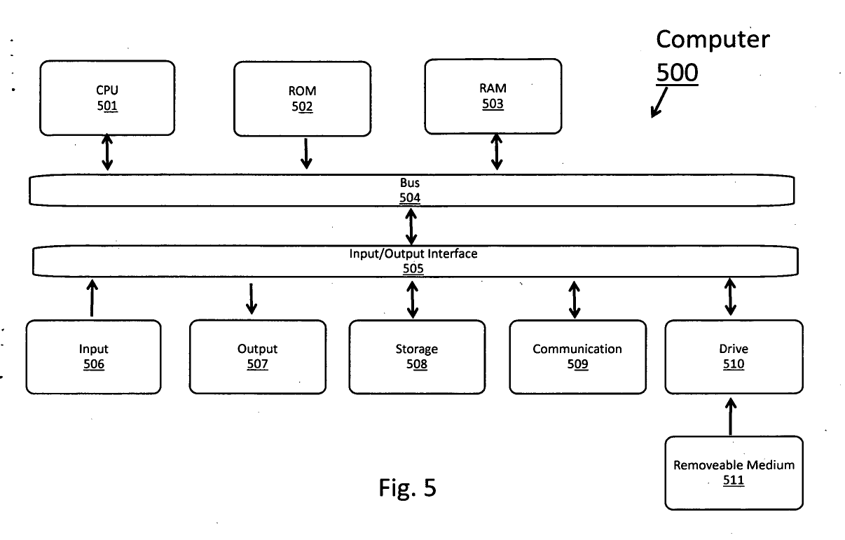

### FIG. 5

The system and method described above can be implemented by using hardware. Such hardware can be a single processing device or a plurality of processing devices. Such a processing device can be a microprocessor, a microcontroller, a digital processor computing apparatus, a microcomputer, a part of a central processing unit, a state machine, a logic circuit and/or any device capable of manipulating a signal.

The above system and method can be implemented by either software or firmware. In the case where the above system and method are implemented by software, then a program that constitutes the software is installed, from a storage medium or a network, into a computing apparatus having a dedicated hardware configuration, e.g., a general-purpose computer 500 as illustrated in FIG. 5 that when programs are installed, it becomes capable of performing the various functions of the program.

In FIG. 5, a CPU 501 performs processes in accordance with a program stored in a ROM 502 or a program loaded from a storage device 508 to a RAM 503. In the RAM 503, data required when the CPU 501 performs the processes is also stored as required. The CPU 501, the ROM 502 and the RAM 503 are connected to one another via a bus 504. An input/output interface 505 is also connected to the bus 504.

The following components are connected to input/output interface 505: an input module 506 including a keyboard and a mouse; an output module 507 including a display such as a CRT, a LCD, and a loudspeaker; a storage module 508 including a hard disk; and a communication module 509 including a network interface card such as a LAN card, and a modem. The communication section 509 performs communication processes via a network such as the Internet.

A drive 510 is also connected to the input/output interface 505 as required. A removable medium 511, such as a magnetic disk, an optical disk, a magneto-optical disk, USB key drive or a semiconductor memory, is mounted on the drive 510 as required, so that a computer program read from it is installed in the storage module 508 as required.

In the case where the above-described series of processes are implemented by software, the program that constitutes the software is installed from a network such as the Internet or a storage medium such as the removable medium 511. Examples of the removable medium 511 include a magnetic disk, a floppy disk, an optical disk, a CD, CD-ROM, DVD, SD, USB key drive, a magneto-optical disk, a mini-disk (MD), and a semiconductor memory. Alternatively, the storage medium can be the ROM 502 or a hard disk contained in the storage module 508, which contains the stored program.

It should also be noted that the above-described series can be performed in order of description but need not be performed in that order. Some steps can be performed in parallel or independently of one another.

While the present invention has been described with reference to what are presently considered to be the preferred embodiments, it is to be understood that the present invention is not limited to the disclosed embodiments and is intended to cover various modifications and equivalent arrangements included within the spirit and scope of the appended claims. The scope of the following claims is to be accorded the broadest interpretation so as to encompass all such modifications and equivalent structures and functions.

I claim:

1) A system for status updates comprising:
a processor;
a digital correspondence client configured to:
provide a stationery for composing a correspondence;
a UDF library configured to:
store UDFs comprising UDF rules, and status update logic;
a status update agent configured to:
a) monitor at least one of a content inputted in the correspondence and a property associated with the correspondence;
b) access the UDF library
c) evaluate at least one of the UDF rules against at least one of the content and the property;
d) determine at least one qualified UDF based on UDF rules satisfied by the evaluating;
e) execute the status update logic associated with the qualified UDFs to return a plurality of results based on at least one of the content and the property;
f) generate a composite status update with the plurality of results; and
g) append the composite status update to the correspondence.

2) The system in claim 1, wherein the status update agent is configured to compare a UDF rule to a correspondence text and wherein the correspondence text can be at least one of a keywords or a recipient contacts.

3. The system in claim 1, wherein the status update agent is configured to compare a UDF rule to a correspondence property and wherein the correspondence property can be at least one of:
a) a temporal states associated with the correspondence;
b) a social relationships associated with a composer, a recipients or a group; and
c) a security ratings associated with the composer, a recipients or a group.

4. The system in claim 3, wherein the status update agent is configured to determine if at least one of the UDF rules is satisfied at least in part by comparing the UDF rule against at least one of the correspondence text and correspondence property.

5. The system of claim 3, wherein the status update agent is configured to determine a temporal state property associated with the correspondence, wherein the temporal state comprises at least one of:
a) a time,
b) a date,
c) an event,
d) an event associated with the composer, and
e) a season

6. The system in claim 1, wherein the status update agent is configured to reevaluate the outputted composite status update based at least in part on a updated content or a updated property associated with the correspondence.

7. The system of claim 1, wherein the status update agent is configured to generate a site that comprises at least one of a local address, an external address, and results based at least in part on the UDF, UDF rules, and status update logic.

8. The system of claim 1, wherein the status updates comprises at least one of a graphic, a picture, a photo, a video, a animation, a diagram, a graph, a chart, a sparkline, or a map.

9. The system of claim 1, wherein the UDF is configured to be created by at least one of a user or a group.

10. The system of claim 1, wherein the UDF is configured to be a scalar function or a table function

11. The apparatus of claim 1, wherein the UDF is configured to self-terminate upon a UDF rules being satisfied.

12. The apparatus of claim 1, wherein the UDF is comprised of UDF rules, UDF parameters, and status update logic.

13. A method for status updates, comprising:
a) monitoring a correspondence for at least one of a content and a property;
b) accessing a library of UDFs comprised of a UDF rules and a status update logics;
c) evaluating at least one of the UDF rules against at least one of the content and the property;
d) determining at least one qualified UDF based on UDF rules satisfied by the evaluating;
e) executing the status update logic associated with the qualified UDFs to return a plurality of results based on at least one of the content and the property;
f) generating a composite status update with the plurality of results; and
g) appending the composite status update to the correspondence.

14. The method of claim 13, wherein the evaluating comprises comparing a UDF rule to a correspondence text and wherein the correspondence text can be at least one of a keywords or a recipient contacts.

15. The method of claim 13, wherein the evaluating comprises comparing a UDF rule to a correspondence property and wherein the correspondence property can be at least one of:
a) a temporal states associated with the correspondence;
b) a social relationships associated with a composer, a recipients or a group; and
c) a security ratings associated with the composer, a recipients or a group.

16. The method of claim 15, wherein the determining at least one of the UDF rules is satisfied at least in part by comparing the UDF rule keyword against at least one of a correspondence text and correspondence property.

17. The method of claim 13, further comprising querying the composer to accept, not accept, or edit the appended composite status update.

18. The method of claim 13, further comprising formatting the correspondence to be compatible with the appended composite status update.

19. A machine readable storage media comprising logic which when executed causes a processors to perform operations that comprise:
monitoring a correspondence for at least one of a content and a property;
accessing a library of UDFs comprised of a UDF rules and a status update logics;
evaluating at least one of the UDF rules against at least one of the content and the property;
determining at least one qualified UDF based on UDF rules satisfied by the evaluating;
executing the status update logic associated with the qualified UDFs to return a plurality of results based on at least one of the content and the property;
generating a composite status update with the plurality of results; and
appending the composite status update to the correspondence.
